(19) United States
(12) Patent Application Publication
(10) Pub. No.: US 2006/0169720 A1
(43) Pub. Date: Aug. 3, 2006

(54) Chilled liquid dispensers

(76) Inventor: Stephen James Vipond, Bishop Auckland (GB)

Correspondence Address: Ira S Dorman, 330 Roberts Street, Suite 200, East Hartford, CT, 06108, US

(21) Appl. No.: 10/543,858

(22) PCT Filed: Feb. 2, 2004
(86) PCT No.: PCT/GB04/00410

§ 371 Date: Jul. 28, 2005

(30) Foreign Application Priority Data
Feb. 5, 2003 (GB) 0302560.8

(51) Int. Cl. B67D 5/62

(52) U.S. Cl. 222/146.6

(57) ABSTRACT

Ambient liquid is supplied from a bottle to a reservoir (3) which is surrounded by cooling coils (44) within a heat-insulating receptacle (40). Chilled liquid may be drawn off from the bottle and dispensed through a discharge outlet. The reservoir (3) also supplies chilled liquid to a pressurised oxygenating vessel (12) and a pressurised carbonating vessel (22) for supplying chilled and gassed liquid to respective discharge outlets. The coils (44) provide a heat exchange cooling surface which surrounds the reservoir (3) and the pressure vessels (12, 22), and the reservoir is in mutual heat exchange contact with the two pressure vessels such that there is greater heat transfer between the reservoir and the pressure vessels than there is between each of the pressure vessels and the cooling coils (44). The arrangement results in reduced manufacturing cost with fewer internal components and reduced internal volume without risk of damage through freezing of the pressure vessels when ambient liquid enters the reservoir (3).

This invention relates to dispensers for chilled liquids.

### BACKGROUND

WO 02 051 739 A2 describes a liquid dispenser in which water supplied from a bottle is pre-chilled in a reservoir from which cooled water may be dispensed from a still water outlet. A water pump transfers water from the reservoir into a pressurised oxygenating vessel, forcing it under pressure into an oxygen space within the vessel to entrain oxygen into the water. The pressure vessel is received in a conductive holder cooled by a peltier element. Oxygen-enriched water may be dispensed from the pressure vessel by means of an oxygenated water outlet. For hygiene purposes the reservoir and oxygenating vessel can be removed from the respective cooling systems and replaced along with the associated tubing.

The provision of two separate cooling systems for the reservoir and pressure vessel involves a considerable cost overhead and occupies valuable space within the dispenser. On the other hand, the two systems usually have different cooling requirements. For example, if a substantial volume of chilled water is drawn off from the first discharge outlet a significant quantity of heat must be removed from the reservoir to return its contents to the target temperature. If, in the meantime, little or no oxygenated water has been removed, the contents of the oxygenating vessel are still at the required temperature and further cooling of the liquid in the oxygenating vessel would present a serious risk of freezing, possibly resulting in serious damage.

The present invention seeks to provide a new and inventive form of chilled liquid dispenser of the kind which includes a reservoir and at least one other vessel from which chilled liquid can be drawn off separately, which has a reduced manufacturing cost with fewer internal components and reduced internal volume without posing a risk of damage through over-cooling.

### SUMMARY OF THE INVENTION

The present invention provides a chilled liquid dispenser having:

a reservoir and at least one other vessel which are arranged to receive liquid from a liquid source;

respective discharge outlets for dispensing liquid from the reservoir and the or each other vessel; and

cooling means for cooling liquid in the reservoir and the or each other vessel;

characterised in that the cooling means includes a heat exchange surface which at least partially surrounds the reservoir and the or each other vessel, and the reservoir is in mutual heat exchange contact with the or each other vessel, the arrangement being such that there is greater heat transfer between the reservoir and the or each other vessel than there is between the or each other vessel and the heat exchange surface.

It is generally desirable to maintain good thermal contact between the or each vessel and the heat exchange surface (e.g. evaporator coils). In such circumstances, the area of mutual contact between the reservoir and the or each other vessel should be greater than the area of contact between the or each other vessel and the heat exchange surface of the cooling means. However, the same effect could be achieved by providing a thermal break between the fluid in the or each vessel and the heat exchange surface of the cooling means whilst maintaining a large contact area.

Although the contacting areas of the reservoir and the or each other vessel may be flat, better heat exchange is ensured if the area of mutual contact is formed by a convex wall portion of the each other vessel which is in contact with an area of the reservoir which provides a correspondingly concave wall portion.

The invention is particularly applicable to dispensers in which the liquid source is arranged to supply liquid to the reservoir and the reservoir is, in turn, arranged to supply chilled liquid to the or each other vessel.

The cooling means is preferably controlled by a temperature sensor which is arranged to monitor the temperature of the reservoir. The sensor responds to a rise in temperature as a consequence of warmer supply liquid replacing chilled liquid dispensed directly from the reservoir, or replacing liquid which has been transferred to the or each other vessel to replace liquid dispensed from said vessel or vessels.

Mutual heat exchange contact is assisted if the gas pressure in the or each other vessel is greater than the pressure within the reservoir.

The invention is particularly applicable to dispensers in which the or each other vessel is arranged to be charged with gas from a gas supply. The liquid from the reservoir is preferably injected into the gas space within the or each other vessel by means of a liquid pump.

Although the invention is applicable to dispensers having only a single other vessel even greater advantages are achieved in dispensers having a plurality of such other vessels all arranged in mutual heat exchange contact with the reservoir. In such cases, the dispenser may be simplified if said other vessels are charged with gas at different pressures and the liquid flow from the pump to the lower pressure vessel is controlled by a shut-off valve.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a is a schematic diagram showing the internal components of a water cooler in accordance with the invention;

FIG. 2 is a general view of the main reservoir and two pressure vessels for use in the water cooler;

FIG. 3 is a vertical section through the reservoir and pressure vessels housed in a cooling receptacle; and

FIG. 4 is a horizontal section at the level IV-IV in FIG. 3

### DETAILED DESCRIPTION OF THE DRAWINGS

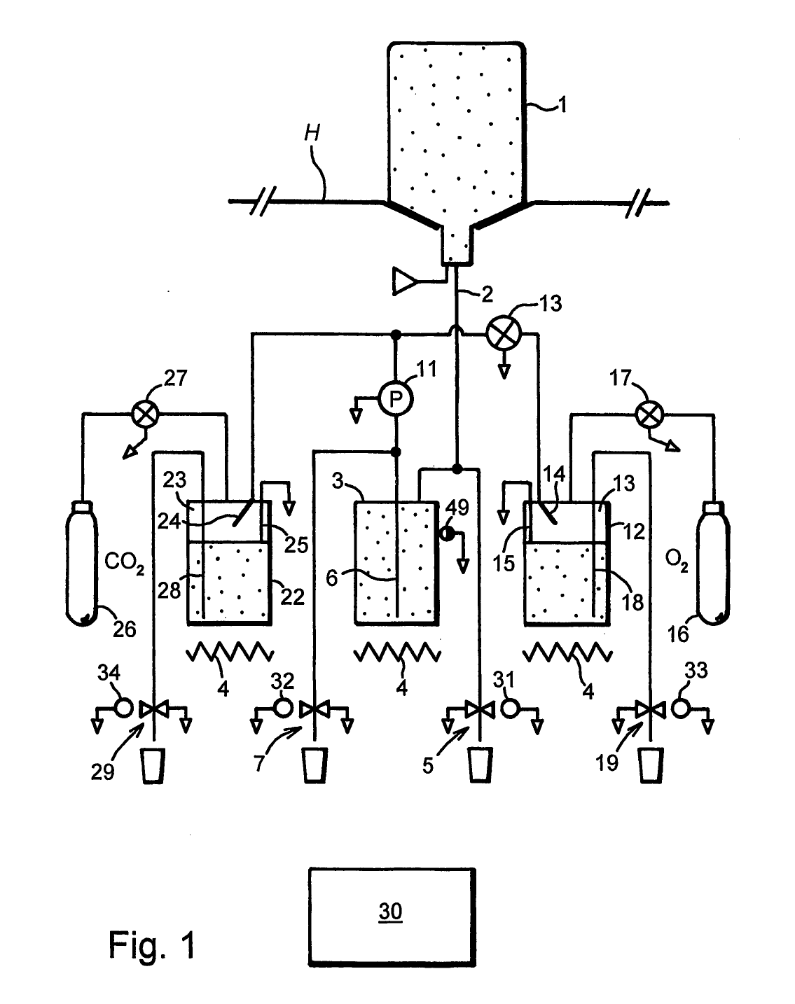

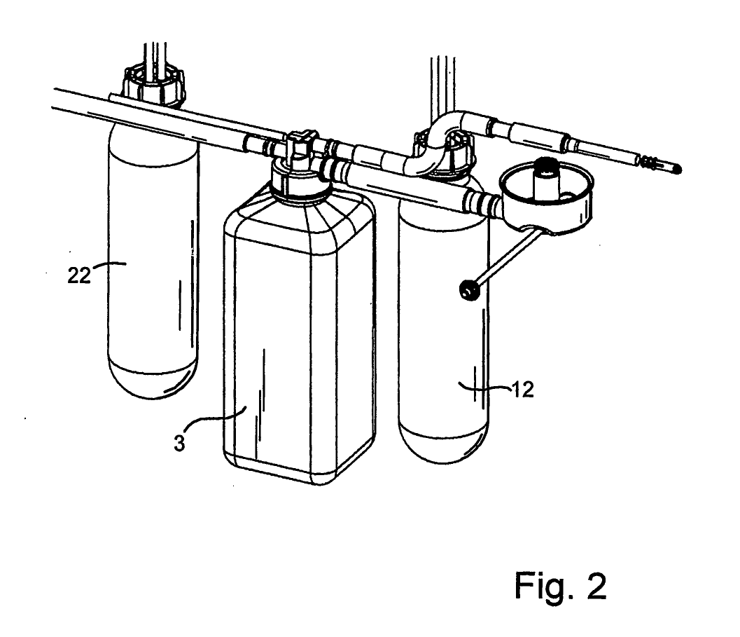

Referring to FIG. 1, the water cooler has a housing H which provides a seat for receiving an inverted water bottle 1. Water passes through the neck of the bottle 1 and travels via a feed tube 2 to a low pressure reservoir 3 formed by a rectangular or square section container of flexible plastics such as PET (see FIG. 2). The contents of the reservoir 3 can be chilled by a cooling system 4, to be described further below. Water at room temperature can be drawn off from the tube 2 before it reaches the reservoir, to be dispensed from an ambient water outlet 5 controlled by a solenoid-operated valve. Chilled still water can be drawn from the reservoir via a dip tube 6 and dispensed through a chilled water outlet 7 controlled by another solenoid-operated valve. (The dispensing outlets of the cooler could be controlled by manually operated pinch valves, if desired.)

Chilled water may also be taken from the reservoir by a pump 11 which feeds an oxygenating pressure vessel 12 via a solenoid-operated shut-off valve 13. Referring again to FIG. 2, the oxygenating vessel is generally cylindrical and may be moulded from PET or similar plastics. Water enters a gas space 13 at the top of the vessel 12 through an injector nozzle 14. The bottom part of the vessel contains water, the water level being determined by a suitable level sensor 15. The cooling system 4 also chills the contents of the oxygenating vessel 12. The gas space 13 is charged to a pressure of about 3 bar with oxygen from a cylinder 16 controlled by a solenoid-operated gas valve 17. A draw tube 18 removes oxygenated water from the bottom of the vessel to be dispensed from an oxygenated water outlet 19 controlled by another solenoid-operated valve.

Chilled water may also be fed by the pump 11 to a carbonating pressure vessel 22 which, as shown in FIG. 2, is also generally cylindrical and moulded from PET or similar plastics. Water enters a gas space 23 at the top of the vessel 22 through an injector nozzle 24. The bottom part of the vessel contains water, the level being determined by a level sensor 25. The cooling system 4 also chills the contents of the carbonating vessel 22. The gas space 23 is charged to a higher pressure than that of the oxygenating vessel 12, e.g. about 4 bar, receiving carbon dioxide from a CO₂ cylinder 26 controlled by a solenoid-operated gas valve 27. A draw tube 28 removes oxygenated water from the carbonating vessel to be dispensed from a carbonated water outlet 29 controlled by a further solenoid-operated valve.

Back-pressurisation of the reservoir 3 and bottle 1 is normally prevented by the pump 11, although non-return valves may be provided if necessary.

The operation of the water cooler is overseen by an electronic controller 30, which receives input from various sensors and operates the water pump 11, cooling system 4 and solenoid valves. The controller operates the dispensing valves of the four water outlets 5, 7, 19 and 29 in response to manual operation of respective push switches 31-34.

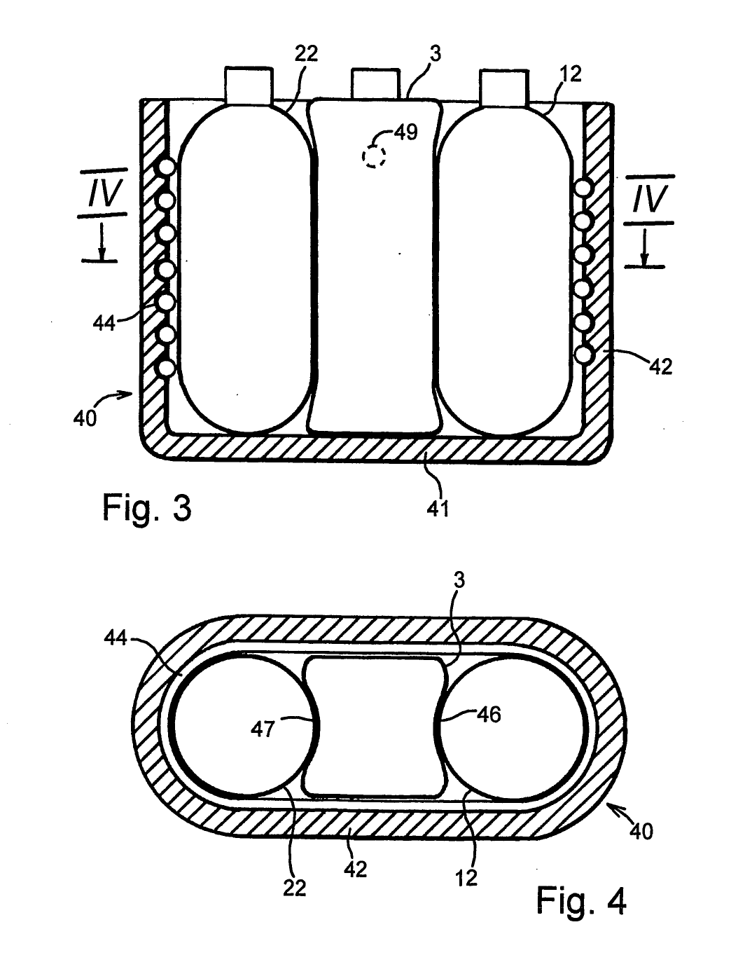

Referring now to FIGS. 3 and 4, the reservoir 3 and pressure vessels 12 and 22 are received within a heat-insulating receptacle 40, e.g. of foamed polystyrene. The receptacle has a bottom wall 41 which, in plan view, is of elongate shape with semi-circular ends, surrounded by an upstanding side wall 42. Evaporator coils 44 are recessed into the inner surface of the side wall 42, forming part of the cooling system 4 which is of a conventional refrigerant system including a compressor, expansion valve and condenser. Other forms of cooling system can also be used, e.g. a thermoelectric cooling system. The reservoir and pressure vessels are inserted into the open top of the receptacle 40 with the two pressure vessels 12 and 22 on opposite sides of the reservoir 3. The pressure vessels deform the sides of the reservoir inwardly as shown, forming efficient heat exchange areas 46 and 47 between the reservoir 3 and each pressure vessel 12 and 22. Since the two vessels 12 and 22 are normally operated at a higher pressure than the reservoir 3, as described, the wall of the reservoir 3 conforms to the shape of the pressurised outer vessels ensuring that good thermal contact is maintained. The two pressure vessels also contact the evaporator coils 44 as shown, but the total area of heat-exchange contact between each pressure vessel 12, 22 and the evaporator coils 44 is less than the areas of contact 46, 47 with the reservoir 3.

The cooling system 4 is operated to maintain a target temperature within the receptacle 40, sensed by a single temperature probe 49 (e.g. a thermistor) located towards the top of the reservoir 3.

When a user operates push-switch 32 to dispense chilled still water from the reservoir 3 via discharge outlet 7, the controller opens the associated solenoid valve allowing the desired quantity of chilled water to be dispensed, as determined by the length of time for which the switch is depressed. Water removed from the reservoir 3 is replaced by ambient water from the bottle 1, and the rise in temperature operates the cooling system 4 to reduce the temperature to the target figure. Such operation of the cooling system tends to further reduce the temperature of the water in the pressure vessels 12 and 22, but this is offset by an increase in temperature by heat transfer from the reservoir 3 across the heat exchange areas 46 and 47. As a result, the reservoir and pressure vessels tend to maintain a common temperature removing any risk of freezing the contents of the two pressure vessels.

If the user operates the push button 33 to dispense oxygenated water the dispensing solenoid opens the valve 19 allowing the gas pressure in the vessel 12 to dispense oxygenated water. When the sensor 15 detects a fall in water level the controller opens the shut-off valve 13 and starts the pump 11 to inject chilled water into the oxygenating vessel. Although there is an open pathway to both pressure vessels the water flow takes the route of least resistance, i.e. to the lower pressure oxygenation vessel. Water removed from the reservoir 3 is replenished by ambient water from the bottle 1, and the resulting rise in temperature causes the cooling system to operate. Although this tends to reduce the temperature of the pressure vessels 12 and 22, heat transfer from the reservoir 3 across the heat exchange areas 46 and 47 ensures that the reservoir and pressure vessels tend to attain a common temperature, heating the pressure vessels and cooling the reservoir.

When the oxygenated water dispensing switch 33 is released the dispensing valve 19 closes but the water pump 11 continues to run until the water level in the oxygenation vessel 12 is replenished. The pump then stops and the shut-off valve is closed. The gas valve 17 is then opened for a sufficient time for the oxygenation level in the pressure vessel 12 to be replenished up to the regulated pressure.

The dispensing of carbonated water from the carbonation vessel 22 proceeds in a similar manner except that the shut-off valve 13 remains closed. By operating the two vessels 12 and 22 at different pressures and providing a simple on/off valve in the water supply to the lower pressure vessel it is possible to ensure reliable operation with small low cost components.

It will be appreciated that the features disclosed herein may be present in any feasible combination. Whilst the above description lays emphasis on those areas which, in combination, are believed to be new, protection is claimed for any inventive combination of the features disclosed herein.

1. A chilled liquid dispenser having:
a reservoir and at least one other vessel which are arranged to receive liquid from a liquid source;
respective discharge outlets for dispensing liquid from the reservoir and the or each other vessel; and
cooling means for cooling liquid in the reservoir and the or each other vessel;
characterised in that the cooling means includes a heat exchange surface which at least partially surrounds the reservoir and the or each other vessel, and the reservoir is in mutual heat exchange contact with the or each other vessel, the arrangement being such that there is greater heat transfer between the reservoir and the or each other vessel than there is between the or each other vessel and the heat exchange surface.

2. A chilled liquid dispenser according to claim 1, in which the area of mutual contact between the reservoir and the or each other vessel is greater than the area of contact between the or each other vessel and the heat exchange surface of the cooling means.

3. A chilled liquid dispenser according to claim 1, in which the area of mutual contact between the reservoir and the or each other vessel is formed by a convex wall portion of the each other vessel which is in contact with an area of the reservoir which provides a correspondingly concave wall portion.

4. A chilled liquid dispenser according to claim 1, in which the liquid source is arranged to supply liquid to the reservoir and the reservoir is, in turn, arranged to supply chilled liquid to the or each other vessel.

5. A chilled liquid dispenser according to claim 4, in which the cooling means is controlled by a temperature sensor which is arranged to monitor the temperature in the reservoir.

6. A chilled liquid dispenser according to claim 1, in which the gas pressure in the or each other vessel is greater than the pressure within the reservoir.

7. A chilled liquid dispenser according to claim 1, in which the or each other vessel is arranged to be charged with gas from a gas supply.

8. A chilled liquid dispenser according to claim 7, In which liquid from the reservoir is injected into the gas space within the or each other vessel by means of a liquid pump.

9. A chilled liquid dispenser according to claim 1, in which there are a plurality of such other vessels all arranged in mutual heat exchange contact with the reservoir.

10. A chilled liquid dispenser according to claim 8, in which there are a plurality of such other vessels all arranged in mutual heat exchange contact with the reservoir, said other vessels are charged with gas at different pressures and the liquid flow from the pump to the lower pressure vessel is controlled by a shut-off valve.
